(19) United States
(12) Patent Application Publication
(10) Pub. No.: US 2021/0246833 A1
(43) Pub. Date: Aug. 12, 2021

(54) POWER PLANT WITH NATURAL GAS REGASIFICATION

(71) Applicant: Siemens Aktiengesellschaft, Munich (DE)

(72) Inventors: Carsten Graeber, Erlangen (DE); Uwe Juretzek, Erlangen (DE)

(73) Assignee: Siemens Aktiengesellschaft, Munich (DE)

(21) Appl. No.: 16/972,777

(22) PCT Filed: May 17, 2019
(86) PCT No.: PCT/EP2019/062820

§ 371 Date: Dec. 7, 2020

(30) Foreign Application Priority Data
Jul. 13, 2018 (EP) 18183389.8

(51) Int. Cl. F02C 7/224; F02C 3/04

(52) U.S. Cl. CPC F02C 7/224; F05D 2260/20; F05D 2220/32; F02C 3/04

(57) ABSTRACT

A power plant with a gas turbine which includes a compressor, a combustion chamber, and a turbine. The power plant additionally includes a natural gas line for transporting liquid and gaseous natural gas, a natural gas compressor which is connected into the natural gas line for increasing a liquid natural gas pressure, and an expander which is likewise connected into the natural gas line. The power plant additionally includes a first heat exchanger which is connected between the natural gas compressor and the expander for evaporating liquid natural gas and a second heat exchanger for additionally heating the regasified natural gas, wherein the power plant has a waste heat steam generator, and the second heat exchanger is coupled to a condensate preheater in the waste heat steam generator.

### CROSS REFERENCE TO RELATED APPLICATIONS

This application is the US National Stage of International Application No. PCT/EP2019/062820 filed 17 May 2019, and claims the benefit thereof. The International Application claims the benefit of European Application No. EP18183389 filed 13 Jul. 2018. All of the applications are incorporated by reference herein in their entirety.

### FIELD OF INVENTION

The invention relates to a power station plant and also a method for the operation thereof. In particular, the invention concerns the energetically and economically optimal vaporization of liquid natural gas in the case of direct coupling to a gas and steam turbine plant or a gas power station.

### BACKGROUND OF INVENTION

Liquid natural gas (LNG) (T=162° C.) is usually vaporized by means of ambient heat (air/seawater) or chemical heat. As an alternative, concepts which had the objective of utilizing the energy of low-temperature cold by means of cascaded organic Rankine cycles have been developed.

### SUMMARY OF INVENTION

It is an object of the invention to provide a power station plant which makes improved performance or an improved efficiency possible and at the same time can be produced very simply and cheaply. A further object of the invention is to provide a corresponding method for operating such a power station plant.

The invention achieves the object directed to a power station plant by proposing a power station plant having a gas turbine which comprises a compressor, a combustion chamber and a turbine, additionally having a natural gas conduit for the transport of liquid and gaseous natural gas to the gas turbine, a natural gas compressor installed in the natural gas conduit for increasing a liquid natural gas pressure and an expander likewise installed in the natural gas conduit, further comprising a first heat exchanger arranged between natural gas compressor and expander for vaporizing liquid natural gas and a second heat exchanger for heating the regasified natural gas further, wherein the power station plant comprises a waste heat steam generator and wherein the second heat exchanger is coupled to a condensate preheater in the waste heat steam generator.

Coupling the liquid natural gas vaporization to a downstream expander makes it possible to achieve maximal utilization of the low-temperature cold for electric power generation with very high efficiencies. Coupling of the second heat exchanger to a condensate preheater, i.e. to the last heating surface in the waste heat steam generator, heats the previously vaporized natural gas further to about 130-170° C.

It is particularly advantageous for the efficiency of the power station plant for a third heat exchanger to be installed in the natural gas conduit downstream of the expander. Although it is in principle also possible to heat the natural gas to such an extent that even after expansion it can be fed, appropriately preheated, to combustion using the second heat exchanger, so that the use of a third heat exchanger can be omitted for cost reasons, the technically better variant is that having further heating by the third heat exchanger downstream of expansion.

In an advantageous embodiment of the invention, the first heat exchanger is connected via a heat transfer medium circuit into an intake air conduit of the gas turbine.

In a further advantageous embodiment, the first heat exchanger is connected via a heat transfer medium circuit into a cooling system of the power station plant. Here, the heat from the gas turbine intake air or from the cooling system can be used in parallel or in series.

In respect of freezing and heat conduction capability of the heat transfer fluid, it is advantageous for the heat transfer medium circuit to be a water-glycol circuit.

It is advantageous for a hot condensate offtake point for the second heat exchanger to be located downstream in the flow direction of the feed water of a high-pressure feed water pump with appropriately high pressure in order to prevent the natural gas from going into the water-steam circuit in the case of a leakage, which would be disadvantageous from safety aspects.

As an alternative, it is advantageous for a hot condensate offtake point for the second heat exchanger to be located downstream in the flow direction of the condensate of a condensate recirculation pump and the second heat exchanger to be a double-wall safety heat exchanger, as a measure for preventing undesirable going-over of natural gas. This alternative arrangement of the hot condensate offtake point has advantages in terms of efficiency.

As regards the third heat exchanger, it is advantageous for it to be coupled to a feed water system of the waste heat steam generator. After the preheated natural gas has been depressurized with production of work by means of the expander to the gas pressure level necessary for gas turbine operation, a gas temperature of about 40-70° C. is established. In order to achieve the maximum gas turbine fuel temperature which is permissible for performance reasons, the third heat exchanger is arranged in the natural gas conduit between expander and gas turbine. This third heat exchanger draws its heat from the intermediate-pressure or high-pressure feed water of the waste heat steam generator.

This approach can also be used in gas turbine power stations even when no waste heat steam generator is provided in such a power station configuration. The heat transfer surfaces necessary for integration of exhaust gas heat into the second and third heat exchangers can, for example, be arranged in an internal stack bypass of the gas turbine, in which hot exhaust gas is conveyed through a separate channel with heating surfaces and cooled and mixed back into the main exhaust gas stream.

The object directed to a method is achieved by a method for operating a power station plant having liquid natural gas vaporization, in which liquid natural gas is brought to at least 150 bar and heat from a gas turbine intake air and/or from a cooling system of the power station plant is used to gasify liquid natural gas and in which, in a further step, natural gas is heated further by heat exchange with hot condensate from a condensate preheater of a waste heat steam generator.

It is advantageous here for the natural gas which has been heated further is depressurized with production of work by means of an expander to a gas pressure level necessary for gas turbine operation.

Furthermore, it is advantageous for the depressurized natural gas to be heated further by heat exchange with feed water.

In power station plants with a gas turbine but without a water-steam circuit, hot exhaust gas can be conveyed through a channel having heating surfaces for vaporization and heating of liquid natural gas and, after cooling, be mixed again into the main exhaust gas stream.

Coupling of the revaporization to a downstream expander and an associated optimal cold/heat integration with the the gas and steam process via a plurality of heat exchangers makes it possible to achieve a significantly improved gas and steam performance both in respect of the gas and steam power (up to about +10%) and also in respect of the gas and steam efficiency (about +0.3-+0.5%). The concept assumes an LNG tank with subsequent pressure increase to about 150 bar. In a downstream heat exchanger, vaporization of the LNG occurs at high pressure up to a temperature of about 5° C. (temperatures slightly below 0° C. are also permissible as long as sufficient hot water is made available in the second heat exchanger).

The advantage of this concept lies in not only the obvious improvement in the performance but especially in the comparatively inexpensive achievement of this performance improvement, since all components with the exception of the expander (including generator and auxiliary systems) and the second heat exchanger have to be (first heat exchanger and liquid gas pump) or should be (third heat exchanger) used in corresponding LNG-fired power stations.

### BRIEF DESCRIPTION OF THE DRAWINGS

The invention is illustrated in more detail by way of example with the aid of the drawings. The drawings show, schematically and not to scale:

FIG. 1 a gas and steam turbine plant according to the invention and

FIG. 2 a gas turbine plant.

### DETAILED DESCRIPTION OF INVENTION

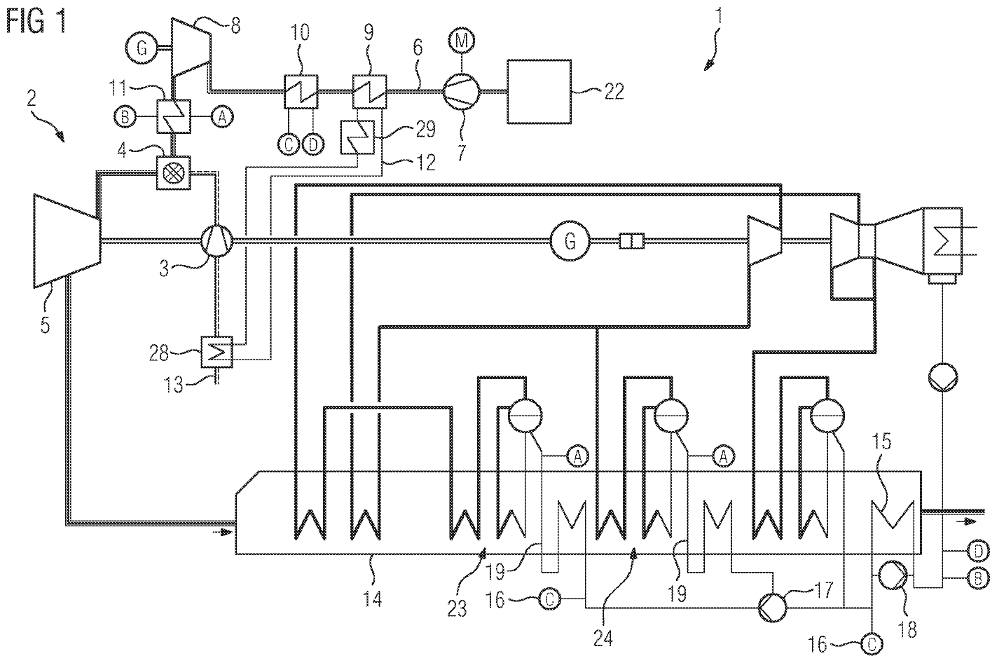

FIG. 1 shows, schematically and by way of example, a power station plant 1 according to the invention configured as a gas and steam turbine plant.

The power station plant 1 comprises a gas turbine 2 having a compressor 3, a combustion chamber 4 and a turbine 5. FIG. 1 shows a natural gas conduit 6 for the transport of liquid and gaseous natural gas branching off from a natural gas tank 22 in which conduit a natural gas compressor 7 for increasing a liquid natural gas pressure and an expander 8 are installed.

Between natural gas compressor 7 and expander 8, there is a first heat exchanger 9 for vaporizing liquid natural gas and a second heat exchanger 10 for further heating of the regasified natural gas. Furthermore, a third heat exchanger 11 is arranged in the natural gas conduit 6 downstream of the expander 8.

The first heat exchanger 9 is connected via a heat transfer medium circuit 12 and a fourth heat exchanger 28 into an intake air conduit 13 of the gas turbine 2 and via a fifth heat exchanger 29 into a cooling system of the power station plant 1. In the working example shown in FIG. 1, fourth and fifth heat exchangers 28, 29 are arranged in series. However, a parallel arrangement is also conceivable.

The heat transfer medium circuit 12 is typically a water-glycol circuit.

When the power station plant 1 is a gas and steam turbine plant as shown in FIG. 1, then it further comprises a waste heat steam generator 14, with the second heat exchanger 10 being coupled to a condensate preheater 15 in the waste heat steam generator 14. FIG. 1 shows both options for hot condensate offtake for the second heat exchanger 10. In the first case, a hot condensate offtake point 16 is located downstream of a high-pressure feed water pump 17. In the second case, the hot condensate offtake point 16 is located downstream of a condensate recirculation pump 18. In this case, the second heat exchanger 10 should be configured as a double-wall safety heat exchanger.

Finally, FIG. 1 shows that the third heat exchanger 11 is coupled to a feed water system 19 of the waste heat steam generator 14.

It is possible to take feed water from the high-pressure part 23 or the intermediate-pressure part 24 for heating the natural gas by means of the third heat exchanger 11. FIG. 1 shows both variants.

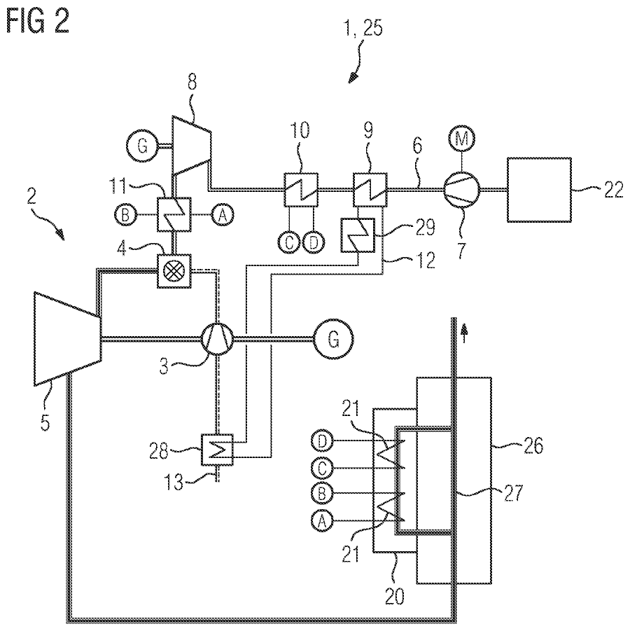

The concept of the invention can also be carried over to other types of power stations. FIG. 2 shows a gas turbine plant 25 with exhaust gas stack 26 and also a stack bypass 20 on the exhaust gas stack 26. The arrangement of the components for regasification of the natural gas is unchanged compared to the plant of FIG. 1. The heat for the second and third heat exchangers 10, 11 is obtained here from the gas turbine exhaust gas via appropriate heat-exchange surfaces 21 in the stack bypass 20 of the exhaust gas stack 26. During operation, part of the exhaust gas is conveyed through the stack bypass 20 and, after transfer of the heat to the appropriate heat transfer surfaces 21, mixed back into the main exhaust gas stream 27.

1. A power station plant comprising:
a gas turbine which comprises a compressor, a combustion chamber and a turbine,
a natural gas conduit for the transport of liquid and gaseous natural gas to the gas turbine, a natural gas compressor installed in the natural gas conduit for increasing a liquid natural gas pressure and an expander likewise installed in the natural gas conduit,
a first heat exchanger arranged between natural gas compressor and expander for vaporizing liquid natural gas and a second heat exchanger for heating the regasified natural gas further, and
a waste heat steam generator, wherein the second heat exchanger is coupled to a condensate preheater in the waste heat steam generator.

2. The power station plant as claimed in claim 1, further comprising:
a third heat exchanger installed in the natural gas conduit downstream of the expander.

3. The power station plant as claimed in claim 1,
wherein the first heat exchanger is connected via a heat transfer medium circuit into an intake air conduit of the gas turbine.

4. The power station plant as claimed in claim 1,
wherein the first heat exchanger is connected via a heat transfer medium circuit into a cooling system of the power station plant.

5. The power station plant as claimed in claim 3,
wherein the heat transfer medium circuit is a water-glycol circuit.

6. The power station plant as claimed in claim 1,
wherein a hot condensate offtake point for the second heat exchanger is located downstream in the feed water flow direction of a high-pressure feed water pump.

7. The power station plant as claimed in claim 1,
wherein a hot condensate offtake point for the second heat exchanger is located downstream in the condensate flow direction of a condensate recirculation pump and the second heat exchanger is a double-walled safety heat exchanger.

8. The power station plant as claimed in claim 2,
wherein the third heat exchanger is coupled to a feed water system of the waste heat steam generator.

9. A method for operating a power station plant having liquid natural gas vaporization, the method comprising:
bringing liquid natural gas to at least 150 bar and using heat from a gas turbine intake air and/or from a cooling system of the power station plant to gasify liquid natural gas, and
further heating natural gas by heat exchange with hot condensate from a condensate preheater of a waste heat steam generator.

10. The method as claimed in claim 9, further comprising:
depressurizing the natural gas which has been heated further with production of work by means of an expander to a gas pressure level necessary for gas turbine operation.

11. The method as claimed in claim 10, further comprising:
further heating the depressurized natural gas by heat exchange with feed water.
